(19) United States
(12) Patent Application Publication
(10) Pub. No.: US 2010/0047151 A1
(43) Pub. Date: Feb. 25, 2010

(54) ELONGATED NANO STRUCTURES

(75) Inventor: Youngtack Shim, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SEOUL NATIONAL UNIVERSITY RESEARCH & DEVELOPMENT BUSINESS FOUNDATION (SNU R&DB FOUNDATION), Seoul (KR)

(21) Appl. No.: 12/195,338

(22) Filed: Aug. 20, 2008

(51) Int. Cl. C01B 31/02

(52) U.S. Cl. 423/445 R; 977/842

(57) ABSTRACT

There are provided techniques for preparing an elongated nano structure. In one embodiment, an insulator may be deposited on a substrate. The insulator and the substrate may then be patterned to define one or more grooves. After a suspension, emulsion, solution or liquid mixture of nano materials is supplied on the insulator and the groove(s), a gas Jet may be applied on the insulator and cause the nano-materials to be trapped in the groove(s). Thereafter, the insulator may be removed.

The described technology generally relates to nanotechnology, and more particularly to elongated nano structures.

### BACKGROUND

With the advent of nano-technology, nano-materials are now applied in various fields of electronics, optics and material science due to their superior mechanical, chemical and electrical properties. For example, the nano-materials are widely used in micro devices such as integrated circuits, electrical connectors used in computer semiconductor chips, batteries, high-frequency antennas, scanning tunnel microscopes, atomic force microscopes and scanning probe microscopes.

Despite such properties of nano-materials, however, applications of nano-materials have been significantly limited mainly because there is a lack of suitable mechanism for manufacturing an elongated nano structure in a desired pattern. Thus, there is a clear need in the art for a device and method, which can efficiently and precisely manufacture the elongated nano structure.

### SUMMARY

The present disclosure provides a free-standing nano structure. The nano structure is made of a plurality of nano-materials and at least one binder. At least a substantial number of the nano-materials have an aspect ratio greater than 100 and are aligned in a predetermined direction, while the binder is mixed with the nano-materials and configured to provide the nano-materials with mechanical integrity as well as at least one of electrical conduction, electrical insulation, optical transparency, opaqueness, and ferromagnetism and to bind the nano-materials. In addition, the structure may be configured to have a length and width, wherein the length of the structure is at least 100 times greater than an average length of the nano-materials, while the width of the structure is at most 1000 times greater than an average thickness of the nano-materials.

The present disclosure also provides a free-standing elongated nano structure. In one embodiment, the structure may define an elongated body which preferentially consists of nano-materials. In another embodiment, the structure may define an elongated body which primarily consists of nano-materials and binders, wherein such binders serve to mechanically couple the nano-materials, to provide electric contact among the nano-particles, and the like. In another embodiment, the structure may define an elongated body through a substantial portion of which the nano-materials are exposed. In another embodiment, the structure may define an elongated body which defines a groove in which the nano-materials are enclosed while exposing at least a portion thereof.

The present disclosure also provides a method for manufacturing an elongated nano structure. In one embodiment, an insulator may be deposited on a substrate. The insulator and substrate may be patterned in order to define one or more grooves. After a suspension, emulsion, solution or liquid mixture of nano materials is supplied on the insulator and one or more grooves, the nano-materials enter the grooves due to gravity, Brownian motion, and the like. A gas jet may be applied onto the suspension, emulsion, solution or mixture such that the nano-materials that are misaligned with the grooves are blown away, that the nano-materials disposed in the grooves are pushed further into the grooves, and that more nano-materials can enter the grooves, thereby trapping a greater amount of the nano-materials in the one or more grooves than otherwise. Thereafter, the insulator may be removed.

This Summary is provided to introduce a selection of concepts in a simplified form that are further described below in the Detailed Description. The Summary is not intended to identify key or essential features of the claimed subject matter, nor is it intended to be used to limit the scope of the claimed subject matter.

### BRIEF DESCRIPTION OF THE DRAWINGS

FIG. 1 shows a perspective view of a substrate manufactured in accordance with one embodiment;

FIG. 2 shows a perspective view of an insulator deposited on the substrate in accordance with one embodiment;

FIG. 3 shows a perspective view of a groove formed within the insulator and substrate in accordance with one embodiment;

FIG. 4 shows a perspective view illustrating a degassing step in accordance with one embodiment;

FIG. 5 shows a perspective view illustrating a step in which a suspension of nano-materials is supplied in accordance with one embodiment;

FIGS. 6-9 show perspective views illustrating how a gas stream is ejected toward the suspension of nano-materials in accordance with one embodiment;

FIG. 10 shows a perspective view of the nano-materials remaining after the gas stream is ejected in accordance with one embodiment;

FIG. 11 shows a perspective view illustrating a drying step in accordance with one embodiment;

FIG. 12 shows a perspective view of a conductor deposited on the insulator in accordance with one embodiment;

FIG. 13 shows a perspective view of a structure after performing a conductor removing step in accordance with one embodiment;

FIG. 14 shows a perspective view of a resultant structure after performing an insulator removing step in accordance with one embodiment; and

FIGS. 15 and 16 show perspective views of a resultant structure after performing a substrate removing step in accordance with one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

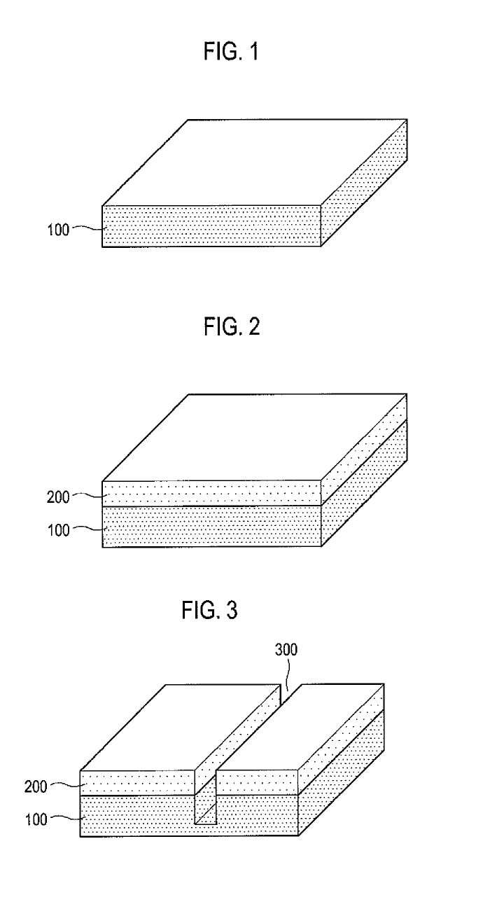

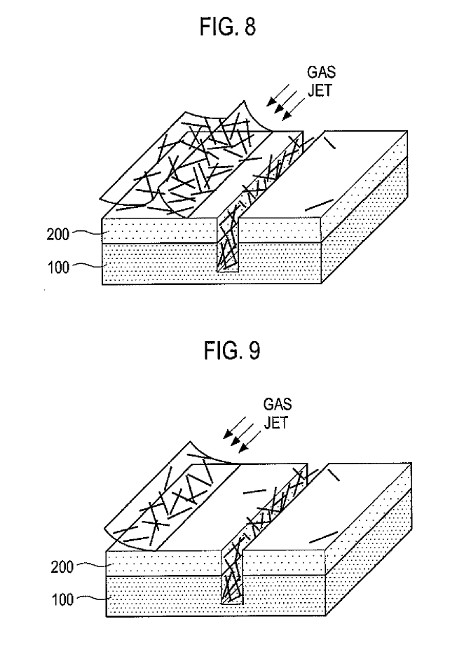

FIGS. 1-16 show perspective views illustrating a method for manufacturing an elongated nano-material structure in accordance with one embodiment. Referring to FIG. 1, the above manufacturing process may begin by preparing a substrate 100. The substrate 100 may be a silicon substrate, a silicon-on-insulator (SOI) substrate, a germanium substrate, a geranium-on-insulator (GOI) substrate, a silicon-geranium substrate and the like. However, any substrate known in the art with a desired mechanical integrity or chemical properties may be used. The substrate 100 may be formed by using conventional manufacturing and preparation techniques. In one embodiment, the substrate 100 may be polished in order to provide an evenly flat surface.

As shown in FIG. 2, an insulator 200 may be deposited on the substrate 100. The insulator 200 may be formed from any conventional insulation material and have a predetermined thickness. In one embodiment, an oxide film such as silicon oxide (SiO₂) may be used as the insulator 200, in which case the silicon oxide may be coated over the insulator in an approximately 750 nm thickness. In another embodiment, the substrate 100 may be coated with a photoresist by using any of the various deposition techniques known in the art such as, but not limited to, spin coating.

Referring to FIG. 3, a groove 300 is formed within the insulator 200 and the substrate 100. The insulator 200 may be patterned by using photolithography or other techniques commonly known in the art to define a single vertical groove 300. Only one groove 300 is shown in FIG. 3 for illustrative purposes. However, it should be noted herein that two or more grooves may be formed according to various embodiments, e.g., parallel, perpendicular or transverse to each other. Further, as shown in FIG. 3, the groove 300 extends not only into the insulator 200 but also into the substrate 100 to a predetermined depth.

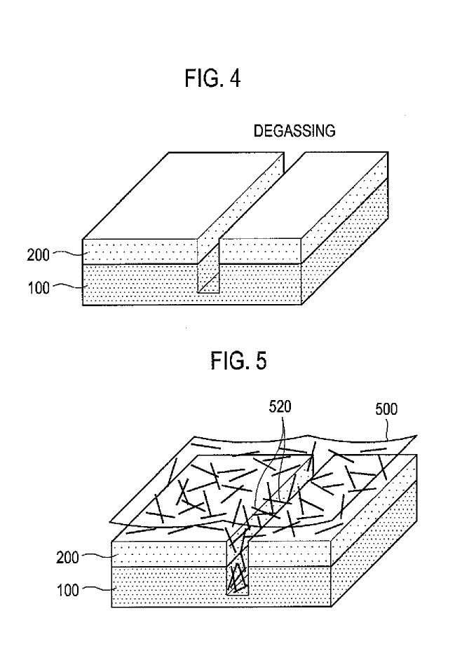

FIG. 4 shows a degassing step in which remnant air or gas on the substrate and insulator may be removed. The degassing step may be conducted for a period of time, which is sufficient to remove the remnant air and gas. The pressure under which the degassing step is conducted may be regulated in order to effectively remove the remnant air and gas. Depending on the need, the degassing step may be repeated more than once.

Referring now to FIG. 5, a suspension of nano-materials may be supplied on top of the insulator 200. In one embodiment, the nano-materials may include single-walled nano tubes, multi-walled nano tubes, nano rods, etc. For example, carbon nanotubes, carbon nanowires, other elongated particles in a nano scale, etc. may be used as nano-materials. In one embodiment, the aspect ratio of the nano-materials may be greater than at least one of 500, 1000, 2000, 4000, 6000, 8000 and 10000. The suspension 500 of nano-materials may be sufficiently viscous so as not to cause any separation of the nano-materials therefrom. The nano-materials may be supplied in other forms such as, for example, an emulsion, solution or liquid mixture according to various embodiments. Further, the shape and size of the nano-materials used may vary depending on the application. For example, the nano-materials included in the suspension 500 may have elongated shapes and be appropriately sized so that they may be accommodated within the groove 300.

As shown in FIG. 5, some of the nano-materials may be trapped in the groove 300. The amount of nano-materials trapped in the groove 300 may depend on numerous factors such as a shape and a dimension of the groove 300, shape and size of the nano materials, curvature of the nano-materials, etc. The nano-materials may not fall into the groove 300 in a controlled manner at this stage. Thus, there may be some nano-materials 520 which fall across a top of the groove 300 and prevent other nano-materials from entering the groove 300. It is appreciated that formation of air or gas bubbles in the groove 300 is effectively prevented due to the degassing step in FIG. 4.

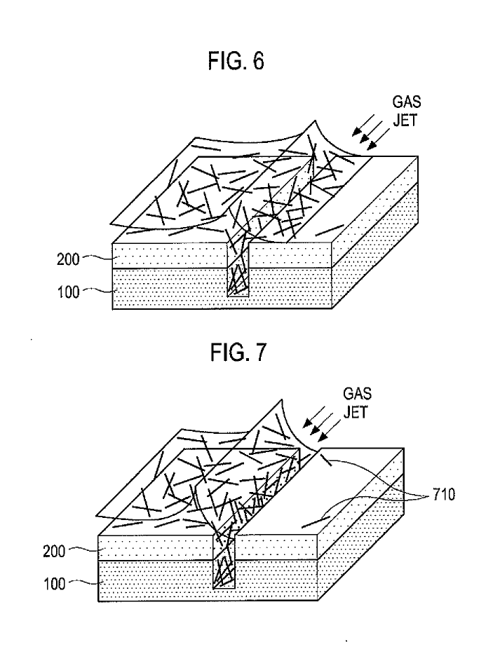

Referring to FIGS. 6-10, a gas jet may be ejected toward the suspension of nano-materials in accordance with one embodiment. Such an ejection may be advantageous in removing the nano materials 520 which are misaligned with the grooves 300 from the top of the groove 300 as well as in squeezing the nano materials already trapped inside the groove 300 into a more compact configuration. As a result, other nano materials which are disposed outside the groove 300 but aligned therewith can enter the groove 300, thereby increasing a total amount of the nano materials in the groove 300. Further details related to the gas jet are provided below. A gas jet device (not shown) may be used to provide and eject the gas jet. As shown in FIGS. 6-10, the gas jet may be ejected, for example, from the right side to the left side. However, it should be noted herein that the ejection direction (as well as an ejection angle) is certainly not limited thereto.

As shown in FIGS. 6-9, the gas jet device may move the suspension 500, which includes the nano-materials, more to the left side as it moves toward said direction. Accordingly, such movement of the suspension 500 has a desired effect upon the nano-materials disposed around the top of the groove 300. For example, due to the movement of the suspension 500, the misaligned nano-materials 520 disposed around the top of the groove 300 may be moved away therefrom, thereby allowing other nano-materials to be inserted into the groove 300. In addition, the suspension 500 may be pressurized by the gas jet ejection. Thus, hydraulic pressure may be generated. The generated hydraulic pressure may cause the nano-materials, which are loosely packed inside the groove 300, to move deeper into the groove. It may also cause the nano-materials disposed around the top of the groove 300 to enter the groove 300. As such, the hydraulic pressure may be a useful facilitator in trapping more nano-materials in the groove 300.

Thus, due to the gas jet ejection, a larger amount of nano-materials may be deposited in the groove 300. Further, the gas jet may also facilitate the nano-materials, which are inside the groove 300, to be properly aligned. That is, by adjusting the gas jet to be perpendicular to the length of the groove 300, the nano-materials aligned with the groove 300 (i.e., aligned normal to the gas jet) may be more apt to fall into the groove 300 compared to those not aligned with the groove. By doing so, the gas jet device not only increases the amount of nano-materials trapped in the groove 300 but may also facilitate the nano-materials to be aligned in the groove 300 along the length of the groove 300.

Along with the movement of the gas jet device, an angle at which the gas jet is ejected from the gas jet device may vary. For example, if the ejection angle with respect to the insulator surface is closer to 90° when the gas jet device accesses the groove 300 and the gas jet ejection approaches the groove 300 (FIG. 7), then the gas jet may blow out the nano-materials, thereby trapping less nano-materials inside the groove 300. Thus, according to the movement of the gas jet device, an ejection or incidence angle at which the gas jet is ejected may be regulated so that the greatest possible amount of nano-materials may be trapped in the groove 300. The optimum ejection angle at each stage with respect to the insulator may depend on various factors such as, but not limited to, width and depth of the groove 300, length of the nano-material, concentration of the nano-materials in the suspension, viscosity of the suspension, a desired amount of nano-materials to be trapped in the groove 300, etc.

In addition to the incidence angle, a volumetric flow rate as well as an ejection pressure may also be important factors in depositing the nano-materials in the groove 300. One of ordinary skill in the art may determine the incidence angle, gas flow rate and gas pressure by considering various factors such as, but not limited to, concentration of the nano materials in the suspension 500, dynamic and kinematic viscosity of the fluid or suspension 500, number of sweepings of the gas jet process, etc.

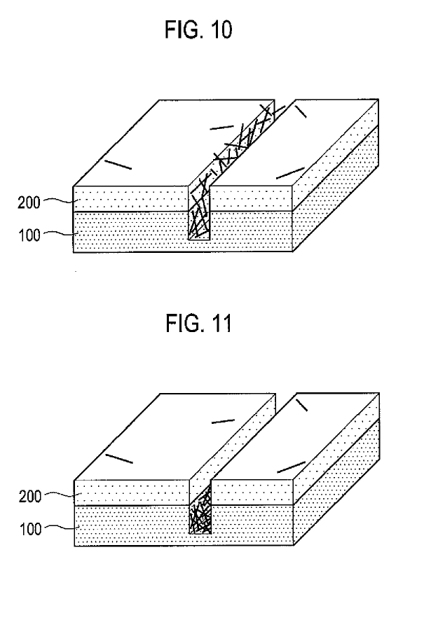

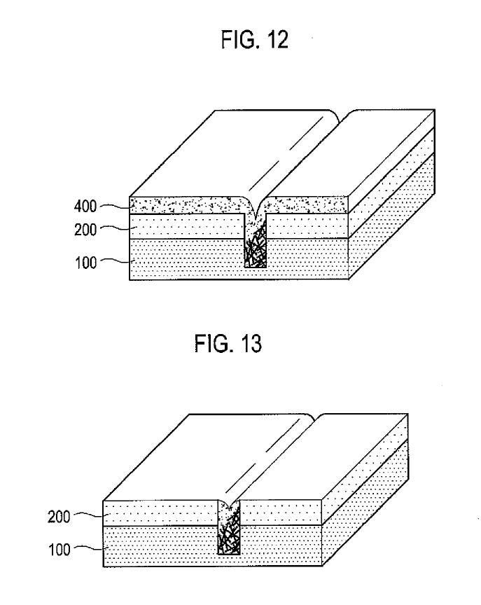

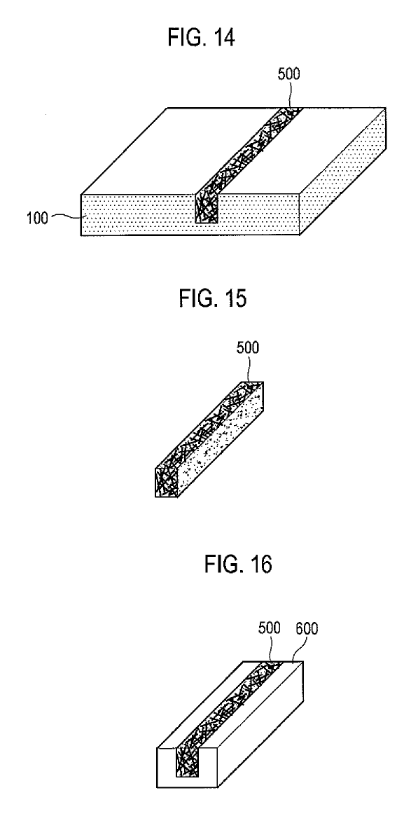

Further, despite such ejection of the gas jet, some of the nano-materials 710 on the insulator 200 may not fall into the groove 300 or may not be removed from the insulator 200 as shown in FIG. 10. The remaining nano-materials may cause malfunction of a device by forming an unwanted electric circuit. Thus, it is desirable to remove such remaining nano-materials. As such, as shown in FIG. 11, a drying step may be conducted to evaporate the remaining suspension from a surface of the insulator 200 and the groove 300. In accordance with one embodiment, once the drying step is completed, a binder such as an electric conductor 400 may be deposited over the insulator 200 and the groove 300 as shown in FIG. 12. Such binder may serve to mechanically couple the nano-materials and to provide electric contact among the nano-materials. Thereafter, as shown in FIGS. 13 and 14, the conductor 400 and the insulator 200 may be removed by using any suitable method such as, but not limited to, photolithography, etching, etc. As a result, an elongated nano structure with the maximum amount of nano-materials may be manufactured. It is appreciated that binders other than electric conductors may be deposited on the insulator 200. For example, a transparent or translucent (or even opaque) material may be deposited as a binder on the insulator when the resulting nano structure is used in optical or display devices. In another example, a ferromagnetic, paramagnetic or other magnetically active (or even inactive) materials may instead be deposited as a binder on the insulator when the resulting structure is used in magnetic devices. As a result, the resulting nano structure of FIG. 14 may be used for various purposes such as, e.g., as a pure electric connector, a sensor, an element of a memory device, and the like.

One of ordinary skill in the art will appreciate that an additional process such as patterning, assembling, etc., may be conducted upon the structure shown in FIG. 14. For example, the substrate 100 may be entirely removed to form an elongated nano structure as shown in FIG. 15. The length of the elongated nano structure, for example, may be at least one of 500, 1000, 2000, 4000, 6000, 8000 and 10000 times greater than the average length of the nano-materials. The width of the elongated nano structure, for example, may be at most one of 800, 600, 400, 200, 100, 50 and 10 times greater than the average thickness of the nano-materials.

Alternatively, a certain amount of substrate 100 may be saved from an etching or lithography process as shown in FIG. 16. As such, the elongated nano structure may be surrounded and mechanically protected by the substrate 600. The substrate 600 may allow the structure to be handled easily and protected from wear and tear. Although the remaining substrate 600 is illustrated as covering three surfaces of the structure in FIG. 16, the remaining substrate 600 may also be configured to cover only one or two surfaces of the structure. The substrate 600 may include transparent (e.g., ITO) or semi-transparent materials when the structure is used as a display or optical component where the substrate is required to transmit at least a portion of light rays.

The elongated nano structure may be structured not to include any conductive materials in the groove 300 by omitting the conductor deposition process shown in FIG. 12 and the conductor removal process shown in FIG. 13. In such a case, the structure may need to be mechanically protected by the substrate.

Although only one elongated nano structure is shown in FIGS. 15 and 16, it should be noted herein that two or more structures may be manufactured by forming two or more grooves according to various embodiments. As a result, multiple elongated nano structures of FIG. 15 may be fabricated by a single process. Alternatively, multiple nano structures may be formed parallel (or perpendicular or transverse) to each other, while all of such structures are enclosed and supported by the substrate 600 as illustrated in FIG. 16.

In light of the present disclosure, those skilled in the art will appreciate that the apparatus and methods described herein may be implemented in hardware, software, firmware, middleware or combinations thereof and utilized in systems, subsystems, components or sub-components thereof. For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link. The machine-readable medium or processor-readable medium may include any medium capable of storing or transferring information in a form readable and executable by a machine (e.g., by a processor, computer, etc.).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A free-standing nano structure, comprising:
a plurality of nano-materials at least a substantial number of which have an aspect ratio greater than 100 and are aligned in a predetermined direction; and
a binder mixed with the nano-materials and configured to provide the nano-materials with mechanical integrity and at least one of electrical conduction, electrical insulation, optical transparency, opaqueness, and ferromagnetism and to bind the nano-materials,
wherein the structure is configured to have a length and a width, wherein the length of the structure is at least 100 times greater than an average length of the nano-materials, and wherein the width of the structure is at most 1000 times greater than an average thickness of the nano-materials.

2. The nano structure of claim 1, wherein the nano-materials include at least one of single-walled nano tubes, multi-walled nano tubes and nano rods.

3. The nano structure of Claim I, further comprising a cover, wherein the nano-materials and binder have a plurality of surfaces and wherein the cover is configured to cover at least one but not all of the surfaces.

4. The nano structure of claim 1, wherein the aspect ratio is greater than at least one of 500, 1000, 2000, 4000, 6000, 8000 and 10000.

5. The nano structure of claim 1, wherein the length of the structure is at least one of 500, 1000, 2000, 4000, 6000, 8000 and 10000 times greater than the average length of the nano-materials.

6. The nano structure of claim 1, wherein the width of the structure is at most one of 800, 600, 400, 200, 100, 50 and 10 times greater than the average thickness of the nano-materials.

7. A method for manufacturing an elongated nano structure, comprising:
preparing a substrate;
depositing an insulator on the substrate;
patterning the insulator and the substrate to define at least one groove therein;
supplying a liquid-state material selected from the group consisting of a suspension of, emulsion of, solution of, and liquid mixture of nano materials over the groove, thereby allowing at least some of the nano materials to enter the groove;
applying a gas jet on the liquid-state material, thereby causing the nano-materials disposed outside the groove to further move into the groove and be trapped therein; and
removing the insulator.

8. The method of claim 7, further comprising depositing a conductor on the insulator and the at least one groove and removing the conductor after the step of applying the gas jet.

9. The method of claim 7, wherein the step of applying the gas jet comprises applying the gas jet to sweep the liquid-state material from one side of the insulator to another side thereof.

10. The method of claim 7, wherein the step of applying the gas jet comprises applying the gas jet more than once to sweep the liquid-state material from the insulator.

11. The method of claim 7, wherein the step of applying the gas jet comprises applying the gas jet at an incident angle with respect to the insulator so as to allow a larger amount of the nano-materials to be trapped in the at least one groove.

12. The method of claim 7, wherein the step of applying the gas jet comprises applying the gas jet at an incident angle determined based on at least one selected from the group consisting of a distance between the gas jet and the at least one groove, a width of the at least one groove, a depth of the at least one groove, a length of the nano-material, a desired amount of the nano-materials to be trapped in the at least one groove, a concentration and viscosity of the liquid-state material, and a number of times of sweeping the gas jet.

13. The method of claim 7, wherein a gas flow rate and a gas pressure of the gas jet is determined based on at least one selected from the group consisting of a concentration and viscosity of the liquid-state material and a number of times of sweeping the gas jet.

14. The method of claim 7, wherein the step of applying the gas jet comprises applying a gas jet onto the insulator so that only a negligible amount of the nano materials remains on the insulator.

15. The method of claim 14, further comprising evaporating the negligible amount of the nano materials from a surface of the insulator and the at least one groove after the step of applying the gas jet.

16. The method of claim 7, further comprising removing at least a portion of the substrate after the step of removing the insulator.

17. The method of claim 7, further comprising removing a remnant air and gas on the substrate and the insulator after the step of patterning the same.

18. The method of claim 7, wherein the substrate includes an ITO.

19. The method of claim 7, wherein the nano-materials include any one of carbon nanotubes and carbon nanowires.

20. An elongated nano structure, comprising:
an elongated block of nano-materials having a plurality of surfaces; and
a protective member for covering at least one of the surfaces of the elongated block.

21. The elongated nano structure of claim 20, wherein the protective member is further configured to cover bottom and two side surfaces of the elongated block.

22. The elongated nano structure of claim 20, wherein the nano-materials include any one of carbon nanotubes and carbon nanowires.

23. An elongated nano structure comprising an elongated block of nano-materials having a plurality of surfaces and conductor materials therein.

24. The elongated nano structure of claim 23, further comprising a protective member for covering at least one of the surfaces of the elongated block.

25. The elongated nano structure of claim 24, wherein the protective member is further configured to cover bottom and two side surfaces of the elongated block.

26. The elongated nano structure of claim 23, wherein the nano-materials include any one of carbon nanotubes and carbon nanowires.
